(19) United States
(12) Patent Application Publication
(10) Pub. No.: US 2002/0194787 A1
(43) Pub. Date: Dec. 26, 2002

(54) Threshold assembly with flexible watertight foam cap seal

(76) Inventor: Joel S. Bennett, Greensboro, NC (US)

Correspondence Address: Womble Carlyle Sandridge & Rice, PLLC, P.O. Box 7037, Atlanta, GA, 30357-0037, US

(21) Appl. No.: 10/103,609

(22) Filed: Mar. 21, 2002

Related U.S. Application Data
(60) Provisional application No. 60/277,585, filed on Mar. 21, 2001.

(51) Int. Cl. E06B 1/70

(52) U.S. Cl. 49/467

(57) ABSTRACT

A threshold assembly (111) has a frame (12) that defines an upwardly open channel (16) in which a threshold cap (18) is vertically adjustably disposed. A gap (21) is formed between the threshold cap and the outside wall of the channel and a flexible polymer layer (22), such as a strip of double sided 100 percent closed cell foam tape, is disposed in the gap. The polymer layer seals the gap against water leakage and deforms up to 300 percent of its dimension in any direction to accommodate vertical adjustment of the threshold cap and other relative movement between the cap and the outside wall of the channel while maintaining a high integrity seal.

Priority to U.S. provisional application serial No. 60/277,585, filed Mar. 21, 2001 is claimed and the disclosure of this provisional application is incorporated in its entirety as if completely set forth herein.

### TECHNICAL FIELD

This invention relates generally to entryway systems for residential and commercial buildings and more particularly to threshold assemblies of entryway systems.

### BACKGROUND

Entryway systems used in building construction generally include a pair of vertically extending door jambs and a head jamb that frame the entryway and receive a hinged door. An elongated threshold assembly is attached at its ends to the bottoms of the door jambs and spans the bottom of the entryway. Many modern threshold assemblies include an extruded aluminum frame defining an upwardly open channel from which a sill slopes outwardly and downwardly. A threshold cap, which may be made of plastic or wood, is disposed in the upwardly open channel and underlies a closed door mounted in the entryway. The threshold cap usually is vertically adjustable to engage and form a seal with a flexible sweep attached to the bottom of the door.

For years, manufacturers of threshold assemblies for entryway systems have struggled with preventing the leakage of rain water beneath the threshold, where it can rot the underlying sub floor. One location where such leakage is a problem is along the gap between the forward wall of the upwardly open channel of the frame and the threshold cap that rides in the channel. This region poses a particular leakage problem because it is exposed to the elements on the outside of the entryway and, in a blowing rain for example, rainwater can be forced by several hydrodynamic mechanisms into the gap. When this happens, water can collect in the channel under the threshold cap, from where it flows to the ends of the threshold assembly and onto the sub floor below.

A variety of attempts to stem leakage along the gap between the threshold cap and its channel have been made over the years. For example, some threshold assemblies include an upstanding dam that forms the upper part of the outside channel wall. The theory is that windblown rainwater moving up the sill toward the threshold cap will be stopped by the dam. It is also common where plastic threshold caps are used to form the threshold cap with a overlapping tongue along its outside edge that overlaps the dam to prevent leakage of rainwater from the top of the threshold cap directly into the gap between the forward edge of the cap and its channel. Where wooden threshold caps are disposed in the upwardly open channel of the frame, a variety of seals have been used to prevent leakage. For instance, one manufacturer installs a flexible rubber bellows in a kerf along the front edge of the threshold cap. The other edge of the bellows is secured in a groove formed along the frame and the bellows spans the gap between the threshold cap and the upwardly open channel of the frame. In another wooden threshold cap threshold assembly, a flexible fin is mounted on the forward edge of the upwardly open channel and the fin rides against the forward edge of the threshold cap in hopes of preventing leakage.

The various techniques used in the past to seal the gap between a threshold cap and its channel have generally been less than successful. For example, flexible bellows-type seals tend to harden, shrink and crack over time, allowing water to seep directly through the bellows and into the channel. Further, dirt tends to collect in the folds of the bellows, which presents an unsightly appearance. Where flexible fins are used to create the seal, dirt that can accumulate between the fin and the surface of the threshold cap breaking the seal. In addition, in cases where the entryway system may not be installed on a perfectly level surface, the threshold assembly can be racked to the extent that the fin looses contact with the threshold cap, resulting in severe leaks and an unsightly appearance. The seal also can be affected by the natural differential thermal expansion and contraction experienced by the various different materials of the assembly. Even with plastic threshold caps with dams and overlapping tongues, leakage still can occur due to the capillary effect between the tongues and the dams.

Accordingly, a need exists for an entryway system that includes a threshold assembly that is positively and permanently sealed along the gap between the threshold cap and the channel in which it rides. The seal should be watertight, should allow for vertical adjustment of the threshold cap within its channel, should allow for racking or twisting of the threshold assembly in certain installations and for differential thermal expansion and contraction, should not tend to collect dirt, and should provide a positive seal for the life of the assembly. It is to the provision of such an entryway system that the present invention is primarily directed.

### SUMMARY

Briefly described, the present invention, in one embodiment thereof, comprises an entryway system wherein the gap between the threshold cap and the upwardly open channel in which it resides is permanently and positively sealed against leakage of rainwater beneath the threshold cap. More specifically, the threshold assembly includes a frame that is at least partially made of extruded aluminum and that defines an upwardly open channel from which a sill slopes outwardly and downwardly. A threshold cap, which may be fabricated of wood, plastic, or another material, is disposed in the upwardly open channel and is positioned to underlie a closed door mounted in the entryway. The threshold cap may include a lip extending from a side thereof. A small gap is defined between the threshold cap and the forward wall of the upwardly open channel. To seal this gap against leakage of rainwater, a layer or strip of polymeric material is disposed in the gap. The material has particular viscoelastic and shape memory properties, which allow the polymeric strip to maintain a seal between the threshold cap and the channel wall. The lip of the threshold cap may extend at least partially over the layer of polymeric material to inhibit debris from entering the gap.

In one embodiment, a strip of double sided highly flexible foam tape is disposed in the gap. One face of the strip of tape is adhesively bonded permanently and securely to the forward edge of the threshold cap and the other face is similarly bonded to the inside surface of the channel wall. The tape thus positively seals the gap between the threshold cap and the forward wall of the channel.

In another embodiment, a strip of single-sided highly flexible foam tape is disposed in the gap. The tape is adhered to one section, such as the aluminum extrusion, and abuts another section, such as the threshold cap, of the entryway system. The single-sided tape forms a seal in the gap by abutting the sections to which it is not adhered. The single-sided tape allows for vertical adjustment and thermal expansion of the entryway system sections while still maintaining the seal within the gap.

The rheologies of both the single-sided and double sided tapes are such that they are viscoelastic and able to be stretched or expanded in any direction up to 300 percent of their dimension in that direction without tearing or losing their material properties. Accordingly, these tapes allow for the vertical adjustment of the threshold cap as necessary to engage the sweep at the bottom of the door without breaking their seals. Also because of these unique properties, the tapes stretch to maintain their seals even when the threshold assemblies are racked or twisted in the event of non-level sub floors or other poor installation of the entryway systems and deform to compensate for differential thermal expansion and contraction. Finally, the tapes do not tend to collect dirt as do bellows-type seals because they exhibit smooth upper surfaces and lack the folds common in such seals.

In yet another embodiment, the layer or strip of polymeric material that seals the gap in the entryway system may not include a specified adhesive side. Rather, the strip may seal the gap simply by frictional engagement with the entryway system sections and/or adhesion provided by the overall polymeric layer instead of an adhesive applied to the viscoelastic polymer strip. Such a strip may be inserted into the gap as a preformed strip or inserted into the gap by pouring, injecting or blowing the polymer material in a state, whereby it will set or cure to take the form of and fill the gap.

In a further embodiment a strip of expandable open cell foam tape is disposed in the gap. The expandable tape is maintained in a compressed state until ready for insertion into the gap. The expandable tape may be applied under compression and then allowed to decompress and expand after being applied. After the expandable tape is applied, a threshold cap is installed in the threshold assembly. The expanded tape will then, over a period of time, expand to fill the gap and form a seal between the threshold cap and the outer wall of the channel. The threshold cap may include a lip extending therefrom that extends over the expandable tape toward the opposite wall of the gap. The threshold lip may act to inhibit debris and other material from entering the gap and contacting the tape.

Thus, an entryway system with a threshold cap sealing mechanism is now provided that successfully addresses the problems and shortcomings of the prior art. The seal is watertight and permanent, allows for adjustment, racking and thermal movement of the threshold assembly, and does not collect dirt that can cause an unsightly appearance. These and other features, objects, and advantages of the entryway system of the present invention will become more apparent upon review of the detailed description set forth below taken in conjunction with the accompanying drawing figures, which are briefly described as follows.

### BRIEF DESCRIPTION OF THE DRAWINGS

FIG. 1 is a perspective view of a threshold assembly that embodies principles of the invention in a preferred form.

FIG. 2 is a cross-sectional view of the threshold assembly of FIG. 1 illustrating better the foam tape seal disposed between the threshold cap and the forward wall of the upwardly open channel in which it resides.

FIG. 3 is a cross-sectional view of a threshold assembly illustrating a non-adhesive embodiment of the polymeric layer of the present invention disposed between the threshold cap and the forward wall of the upwardly open channel in which it resides.

FIG. 4 is a cross-sectional view of a threshold assembly illustrating a threshold cap with a lip extending over the foam tape seal disposed between the threshold cap and the forward wall of the upwardly open channel in which it resides.

FIG. 5 is a perspective view of a threshold assembly illustrating an expandable foam tape disposed between the threshold cap with a lip extending therefrom and the forward wall of the upwardly open channel.

FIG. 6 is a side view of a threshold cap with a lip extending from a side thereof.

### DETAILED DESCRIPTION OF THE PREFERRED EMBODIMENTS

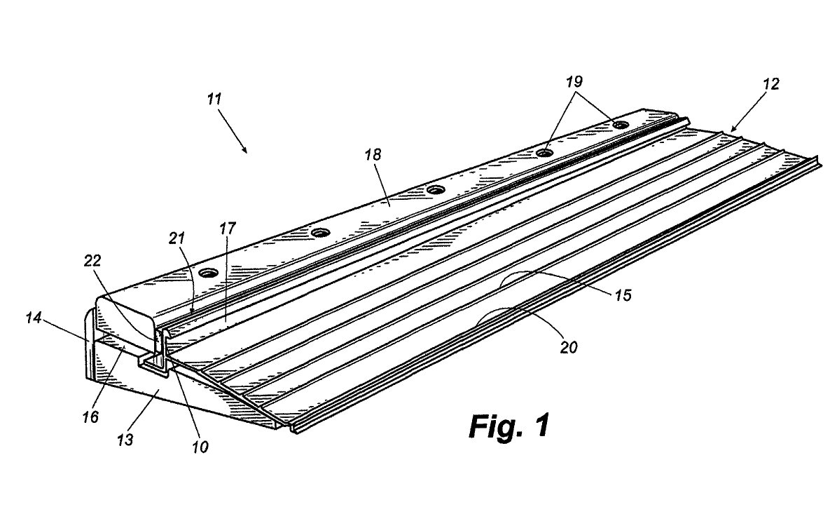

Referring now in more detail to the drawings, in which like reference numerals indicate like parts throughout the several views, FIG. 1 illustrates an entryway threshold assembly that embodies principles of the invention in a preferred form. The threshold assembly 11 comprises a frame 12 that includes an extruded aluminum portion 10 that is attached with appropriate fasteners such as staples to a substrate 13. The substrate 13 preferably is made of a deterioration resistant wood composite material, but may be made of any other material with appropriate support such as, for example, wood or plastic. A nosing strip 14 is attached to the inside edge of the substrate and extends upwardly therefrom. The aluminum portion 10 of the frame 12 is formed with an upstanding dam 17 that defines the outside wall of and upwardly open channel 16 formed by the dam 17, the substrate 13, and the nosing strip 14.

While the frame 12 of the threshold assembly of FIG. 1 has an aluminum portion, a substrate, and a nosing strip, it will be understood that this is not a limitation of the invention. In fact, the threshold assembly can be formed completely from an aluminum extrusion, can be formed completely from an extruded or injection molded plastic material, or may be a combination. The particular construction of the threshold assembly illustrated in FIG. 1 is chosen because it is a common construction and because it serves well to illustrate the invention disclosed herein. Those of skill in the art will understand, however, that a variety of threshold assembly constructions may well be used without departing from the spirit of the invention.

An elongated threshold cap 18 is disposed in and projects upwardly from the upwardly open channel 16. The threshold cap 18 may be formed of wood as illustrated in FIGS. 1-3, or it may be formed of plastic, a composite, or another appropriate material. The threshold cap is positioned to underlie a closed door mounted in an entryway that includes the threshold assembly 11. An array of vertical adjustment screw mechanisms 19 are conventionally provided for adjusting the height of the threshold cap 18 so that it appropriately engages a flexible sweep mounted to the bottom edge of a closed door to form a seal between the bottom edge of the door and the threshold cap.

A relatively narrow gap 21 is defined between the threshold cap and the forward or outside wall of the channel 16. Since this gap 21 is exposed to the elements on the outside of a building structure, it can afford the opportunity for rainwater to leak or seep into the upwardly open channel 16 and ultimately to the sub floor upon which the threshold assembly rests. To seal against such leakage, a strip of highly flexible foam tape 22 is disposed in and fills the gap 21. This tape 22 may include adhesive one or both sides or, as described below, may have no adhesive sides. The unique physical characteristics of the flexible foam tape 22, an example of which is available from the 3M corporation, permits the tape to be stretched or deformed up to 300 percent of its dimension in any direction without cracking, breaking, or otherwise loosing its sealing characteristics. Thus, the tape 22 easily allows for the vertical adjustment of the threshold cap without loosing its seal. Further, in certain installations where the aluminum frame 12 may rack or twist with respect to the substrate 13, which can widen the gap 21, the foam tape 22 stretches to maintain its seal of the gap, especially in the case where the tape is double-sided with adhesive on both faces. Similarly, the tape deforms to accommodate differential thermal expansion and contraction of the various components of the threshold assembly 11. Finally, since the top edge of the foam tape 22 does not exhibit folds such as those found in some bellows-type sealing mechanisms, unsightly dirt and debris does not accumulate along the gap 21 and a clean appearance is maintained.

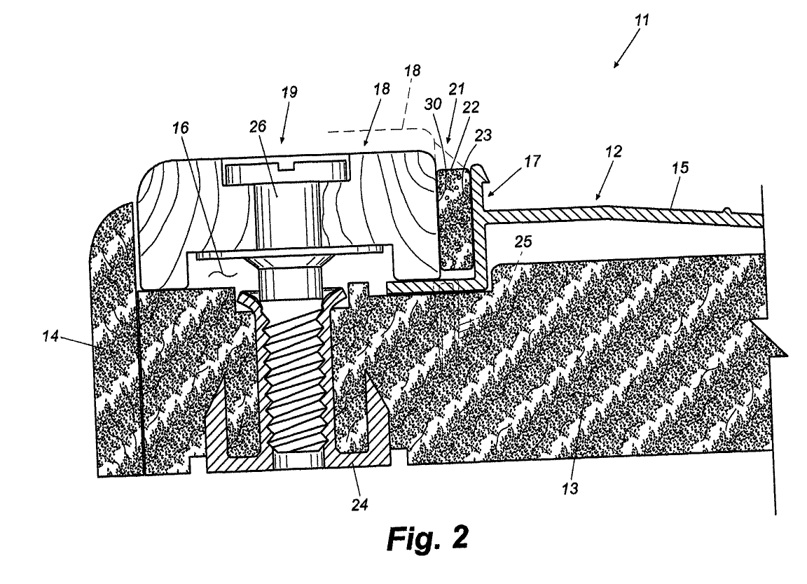

FIG. 2 is a cross-sectional view of a portion of the threshold assembly 11 of FIG. 1 illustrating better some of the features and elements of the invention. As in FIG. 1, the threshold assembly 11 includes a frame 12 including extruded aluminum portion 10 attached with staples 25 to a substrate 13. The aluminum portion 10 is formed with an upstanding dam 17 from which a sill 15 slopes outwardly and downwardly. A nosing strip 14 is attached along the inside edge of the substrate 13 and the nosing strip 14, substrate 13, and dam 17 form an upwardly open channel 16. The threshold cap 18 is disposed in the upwardly open channel 16 for underlying a closed door mounted in an entryway that includes the threshold assembly 11.

Conventionally, vertical adjustment screw mechanisms 19 are provided along the threshold cap 18 for selectively adjusting the vertical position of the threshold cap 18 within the channel 16. In the illustrated embodiment, the vertical adjustment screw mechanism 19 includes an adjustment screw 26 that is treadably received in a treaded grommet 24 mounted within a hole in the substrate 13. It will be understood, however, that a variety of vertical adjustment mechanisms different from the specific example here may be employed and all such mechanisms are considered to be within the scope of the invention. In any event, it will be seen that the threshold cap 18 is vertically adjustable within the upwardly open channel 16. In this regard, a vertically raised position of the threshold cap 18 is illustrated in phantom lines in FIG. 2.

A gap 21 is formed between the forward edge 30 of the threshold cap 18 and the inside surface 23 of the aluminum dam 17 that defines the outside wall of the upwardly open channel 16. The gap 21 is somewhat exaggerated in FIG. 2 for purposes of clarity of discussion; however, in reality the gap likely is relatively narrower than illustrated. For instance, a common dimension of the gap in conventional threshold assemblies may be about 0.12 inches. In any event, a strip of highly flexible 100 percent closed cell foam tape 22 is disposed in and seals the gap 21. A foam tape product suitable for use in the present invention is known as 3M VHB tape available from 3M Research and Development Corporation in St. Paul, Minn. This foam tape product is impervious to water and exhibits unique viscoelasticity in that it can be stretched up to 300 percent of its dimension in any direction without breaking, tearing, or otherwise loosing its physical properties. Furthermore, the tape exhibits natural shape memory properties in that after being stretched up to 300 percent and released, it returns naturally to its original shape.

The tape 22 has opposed faces one or both of which are coated with an industrial adhesive such that, once applied to a surface, activated by application of pressure, and allowed to cure for 72 hours, the adhesive forms a permanent watertight bond that is actually stronger than the foam material of the tape itself. Accordingly, once properly applied, the tape can not be removed intact. Foam tape of this type previously has had a variety of industrial uses including, for example, to bond mutton bars to glass in simulated divided light windows and to mount plastic body parts to the chassis of vehicle in the automotive industry.

The strip of foam tape 22 is disposed in the gap 21 with one of its faces bonded to the inside surface of the aluminum dam 17 and, in the case of tape with double-sided adhesive, with its opposed face bonded to the outside edge 30 of the threshold cap 18. In the case of a single-sided adhesive tape, the adhesive face of the tape bonds to one surface such as the inside surface of the aluminum tam. The strip expands to fill the gap 21 and, after about 1-3 hours, forms a seal even with portions of the threshold assembly to which it is not adhesively bonded. Thus, the strip of foam tape 22 forms a permanent and watertight seal along the length of the gap 21 to prevent seepage of water through the gap and into the upwardly open channel of the threshold assembly.

The unique viscoelastic and shape memory properties of the tape are well suited to its use as a seal in threshold assemblies. More specifically, because of these properties, the tape allows for the vertical adjustment of the threshold cap within the channel. This is illustrated in FIG. 2 by phantom lines that show the threshold cap 18 adjusted to a higher position within the channel 16. As can be seen, as the threshold cap 18 is adjusted higher, the foam tape, in this case double-sided, stretches to maintain its seal along the gap 21 (the upper edge of the tape in this configuration also is shown in phantom lines). Furthermore, unlike flexible bellows-type seals of the past, the top edge of the tape is smooth in all configurations and does not exhibit any folds or gaps where unsightly dirt and debris can collect over time. In the case of single-sided tape, wherein the adhesive is bonded to the dam 17 the seal is maintained by frictional engagement between the tape and the threshold cap 18, even where the tape does not stretch as shown in FIG. 2. Thus, the present invention provides a positive seal along the gap without any of the problems and shortcomings of the prior art.

In addition to accommodating the vertical adjustment of the threshold cap 18, the tape 22 also solves the problems that can occur in some installations when the gap 16 is widened due to differential thermal expansion or a racked or twisted threshold assembly. If this occurs, the strip of tape 22 simply stretches and deforms as necessary to match the changing dimensions of the gap and therefore maintains its seal under even the most extreme conditions.

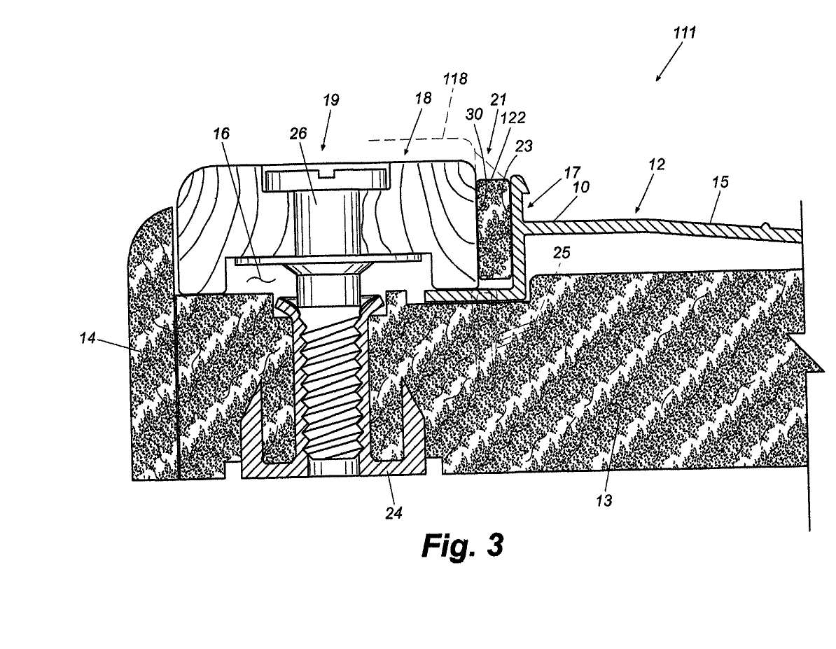

FIG. 3 illustrates an embodiment of a threshold assembly 111 in which a polymer layer 122 is inserted into gap 21 in a form other than a strip of tape. The polymer layer exhibits the same or similar properties as the single-sided and double-sided tapes described above and seals the gap as previously described, but is not in the form of tape. Rather, the polymer layer 122 is inserted into the gap 21 by pouring, blowing, injecting or other suitable means. The polymer layer 122 tends to fill the gap 21 and form a seal while exhibiting similar viscoelastic and shape memory properties as described above.

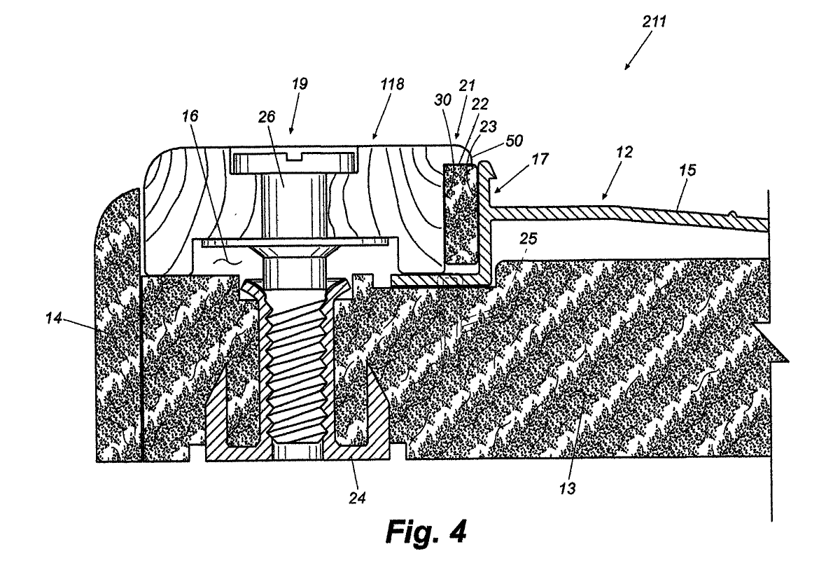

FIG. 4 illustrates an embodiment of a threshold assembly 211 in which the foam tape 22 is a least partially covered by a lip 50 projecting from a side of threshold cap 118. Lip 50 may be integrally formed with threshold cap 118 or attached thereto. Lip 50 generally protects the foam tape and inhibits the introduction of debris and other material into the gap 21. The threshold cap 118 is also shown in FIG. 6 with lip 50. Lip 50 may be coextensive with the elongated threshold cap 118 or may extend along only a portion of the side of the cap.

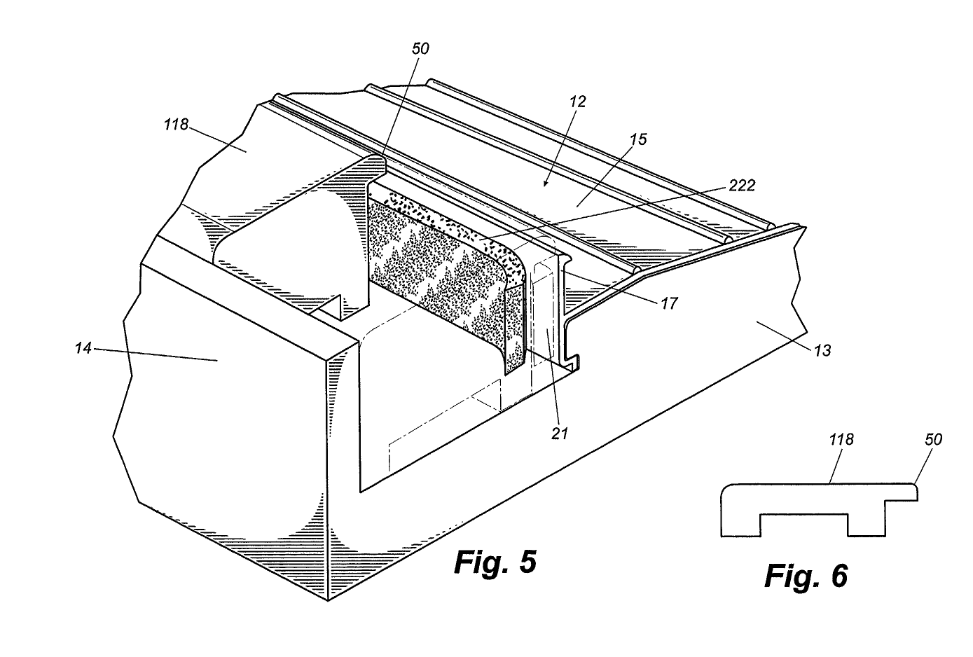

FIG. 5 illustrates another embodiment of a threshold assembly in which an expandable foam tape 222 is disposed in gap 21 between threshold cap 118 and upstanding dam 17. Expandable foam tape 222 includes an open cell structure made of one or more polymers, such as polyurethane impregnated with acrylic. Expandable foam tape 222 may expand to take up more than eight times its original compressed volume. An example of such an expandable foam tape is a product marked under the name WILLSEAL 600 by Illbruck Sealant Systems, Inc. in Minneapolis, Minn. The expandable foam tape 222 is inserted into the gap 21 in a compressed state. Then the threshold cap 18 is installed. The expandable foam tape 222 expands over a period of time in at least one direction to at least partially fill the gap 21. In such a manner, the expandable foam tape 222 can expand to seal the gap and inhibit air and/or water infiltration. The expandable foam tape 222 may exhibit flexibility characteristics similar to the other tapes and polymers described herein or may have limited flexibility in directions other than the direction in which it expands.

The invention has been described herein in terms of preferred embodiments and methodologies. It will be understood by those of skill in the art, however, that a wide range of additions, deletions, and modifications, might well be made to the illustrated embodiments without departing from the spirit and scope of the invention. For instance, the particular construction of the threshold frame assembly with its separate extruded aluminum portion, substrate, and nosing strip is not and should not be considered to be limiting nor should the materials used in the illustrated embodiments. Further, a threshold assembly with a dam 17 has been illustrated; however, the present invention also is applicable to threshold assemblies without such dams. These and other modifications of the illustrated embodiments are possible within the scope of the invention.

What is claimed is:

1. A threshold assembly for installation in an entryway comprising a frame defining an upwardly open channel having an outside wall, a threshold cap disposed in the upwardly open channel for underlying a closed door of the entryway, a gap being defined between the threshold cap and the outside wall of the upwardly open channel, and a flexible polymer layer disposed in and sealing the gap.

2. The threshold assembly of claim 1 and wherein the flexible polymer layer is a strip of flexible tape.

3. The threshold assembly of claim 2 and wherein the strip of flexible tape includes adhesive on two sides thereof.

4. The threshold assembly of claim 3 and wherein the flexible tape is adhesively bonded to the threshold cap and the outside wall of the upwardly open channel.

5. The threshold assembly of claim 1 and wherein the flexible polymer layer stretches in response to vertical adjustment of the threshold cap to maintain the seal.

6. The threshold assembly of claim 2 and wherein the flexible tape is 3M-VHB tape.

7. The threshold assembly of claim 2 and wherein the flexible tape is an expandable open call foam tape.

8. The threshold assembly of claim 2 and wherein the flexible tape includes polyurethane and acrylic polymers.

9. The threshold assembly of claim 1 and wherein the threshold cap includes a lip extending from a side thereof.

10. In a threshold assembly defining an upwardly open channel having an outside wall in which an elongated threshold cap is disposed, the improvement comprising a flexible polymer layer sealing the gap between the threshold cap and the outside wall of the upwardly open channel.

11. The improvement of claim 10 and wherein the flexible polymer layer is adhesively bonded to the threshold cap and the outside wall of the upwardly open channel.

12. The threshold assembly of claim 10 and wherein the flexible polymer layer is a strip of tape.

13. The improvement of claim 12 and wherein the flexible tape is a 100 percent closed cell foam tape.

14. The improvement of claim 10 and wherein the flexible polymer layer stretches and deforms in response to relative movement between the threshold cap and the outside wall of the upwardly open channel.

15. The improvement of claim 14 and wherein the flexible polymer layer has shape memory characteristics to return to its original shape after having been deformed.

16. The improvement of claim 10 and wherein the flexible polymer layer is 3M-VHB tape.

17. The threshold assembly of claim 10 and wherein the flexible polymer layer is an open cell foam tape.

18. The threshold assembly of claim 1 and wherein the flexible polymer layer includes polyurethane and acrylic.

19. The threshold assembly of claim 10 and wherein the elongated threshold assembly includes a lip extending over the flexible polymer layer.

20. For application in a threshold assembly having an upwardly open channel in which a threshold cap resides, a method of sealing the gap between the threshold cap and the outside wall of the channel comprising the step of inserting a layer of flexible polymer in and extending along the gap.

21. The method of claim 20 and wherein the layer of flexible polymer is 100 percent closed cell foam.

22. The method of claim 20, and wherein the layer of flexible polymer is a strip of tape adhesively bonded to the outside wall of the channel.

23. The method of claim 22 and wherein the tape is 3M-VHB tape.

24. The method of claim 20 and wherein the layer of flexible polymer is an open cell foam tape.

25. The method of claim 20 and wherein the layer of flexible polymer includes polyurethane and acrylic polymers.
